(19) United States
(12) Patent Application Publication
(10) Pub. No.: US 2006/0098277 A1
(43) Pub. Date: May 11, 2006

(54) Focusing and adjusting method for binoculars with image-capturing module

(75) Inventor: Chien-Lung Huang, Taichung (TW)

Correspondence Address: FROMMER LAWRENCE & HAUG, 745 FIFTH AVENUE- 10TH FL., NEW YORK, NY, 10151, US

(73) Assignee: ASIA OPTICAL CO., INC.

(21) Appl. No.: 11/311,191

(22) Filed: Dec. 19, 2005

Related U.S. Application Data
(63) Continuation-in-part of application No. 10/931,639, filed on Sep. 1, 2004.

(30) Foreign Application Priority Data
Jan. 19, 2005 (TW) 094101537

(51) Int. Cl. G02B 23/00

(52) U.S. Cl. 359/409

(57) ABSTRACT

A focusing and adjusting method to be implemented using a pair of binoculars having a pair of optical units, an image-capturing unit, and a beam-splitting unit. Each optical unit includes an objective lens unit, an ocular lens assembly distanced from the objective lens unit along a first direction, and a prism assembly disposed therebetween. The beam-splitting unit is disposed between the prism assembly of one optical unit and the image-capturing unit. The method includes: adjusting a distance along a second direction perpendicular to the first direction between the optical units; simultaneously adjusting distances along the first direction between the objective lens units and the prism assemblies of the optical units; and independently adjusting distances along the first direction between the prism assemblies and the ocular lens assemblies of the optical units.

### CROSS-REFERENCE TO RELATED APPLICATIONS

This application is a continuation-in-part (CIP) application of U.S. patent application Ser. No. 10/931,639, entitled “Binoculars” and filed on Sep. 1, 2004, the entire disclosure of which is incorporated herein by reference. This application also claims priority from Taiwanese application no. 094101537, filed on Jan. 19, 2005.

### BACKGROUND OF THE INVENTION

1. Field of the Invention

The present invention relates to a focusing and adjusting method for a pair of binoculars having an image-capturing module, which enables images both viewed by the user through the binoculars and appearing on a screen of the image-capturing module to be focused simultaneously and effectively, and which allows for ocular width adjustment of the binoculars.

2. Description of the Related Art

A typical pair of binoculars having an image-capturing function is realized through a structure in which a digital camera and the binoculars are combined into a single unit. As a result, two separate focusing operations must be performed-one for the binoculars and one for the digital camera. In the case where the digital camera is configured to undergo automatic focusing, the image captured by the digital camera may not be the same as that viewed by the user through the binoculars. Further, such a pair of binoculars does not allow for any ocular width adjustment.

Ideally, the pair of binoculars is fully integrated with an image-capturing module, and should be structured to allow for ocular width adjustment. There is a need, therefore, for a focusing and adjusting method applied to such a pair of binoculars, in which focusing involves a single focusing control for both the binoculars and the image-capturing module, and in which ocular width adjustment of the binoculars is permitted to best suit the particular user of the binoculars.

### SUMMARY OF THE INVENTION

Therefore, the object of this invention is to provide a focusing and adjusting method for a pair of binoculars having an image-capturing module, which enables images both viewed by the user through the binoculars and appearing on a screen of the image-capturing module to be focused simultaneously and effectively, and which allows for ocular width adjustment of the binoculars. The pair of binoculars to which the focusing and adjusting method is applied includes first and second optical units, an image-capturing unit, and a beam-splitting unit. Each of the first and second optical units includes an objective lens unit, an ocular lens assembly spaced apart from the objective lens unit along a first direction, and a prism assembly disposed between the objective lens unit and the ocular lens assembly. The beam-splitting unit is disposed between the prism assembly of the first optical unit and the image-capturing unit. Light entering the objective lens units passes through the prism assemblies for transmission to the ocular lens assemblies, and the beam-splitting unit filters part of the light that passes through the prism assembly of the first optical unit for supply to the image-capturing unit.

The focusing and adjusting method comprises: (a) adjusting an ocular width, which is defined as a distance along a second direction that is perpendicular to the first direction between longitudinal axes of the first and second optical units; (b) simultaneously adjusting a pair of first optical lengths, each of which is defined as a distance along the first direction between the objective lens unit and the prism assembly of either one of the first and second optical units; (c) adjusting a second optical length, which is defined as a distance along the first direction between the prism assembly and the ocular lens assembly of the first optical unit; and (d) adjusting a third optical length, which is defined as a distance along the first direction between the prism assembly and the ocular lens assembly of the second optical unit.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart of a focusing and adjusting method for binoculars having an image-capturing module according to a preferred embodiment of the present invention;

FIG. 2 is a perspective view illustrating an example of binoculars having an image-capturing module to which the focusing and adjusting method of the present invention is applied;

FIG. 3 is a view similar to FIG. 2, but illustrating the binoculars with a housing thereof removed;

FIG. 4 is a schematic view of the binoculars of FIG. 3;

FIG. 5 is a fragmentary sectional view of the binoculars of FIG. 3, illustrating a lens barrel and an ocular lens assembly;

FIG. 6 is a schematic view of the binoculars of FIG. 3, illustrating various focusing and adjusting lengths between elements; and

FIG. 7 is a view similar to FIG. 6, illustrating adjustment in an optical length.

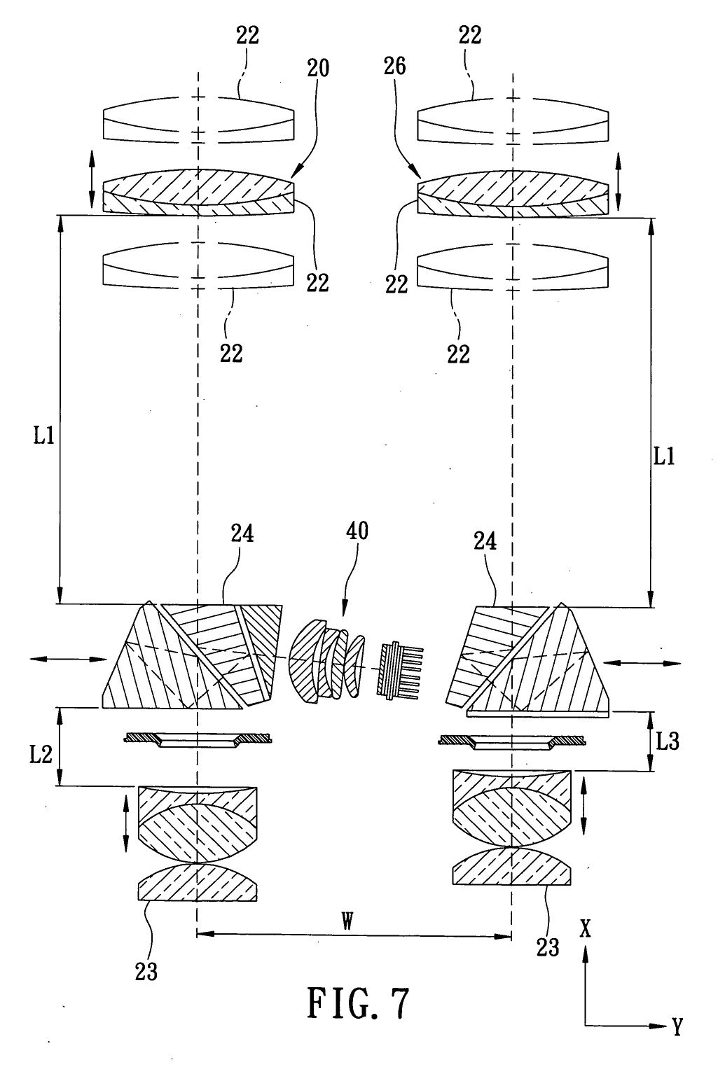

### DETAILED DESCRIPTION OF THE PREFERRED EMBODIMENT

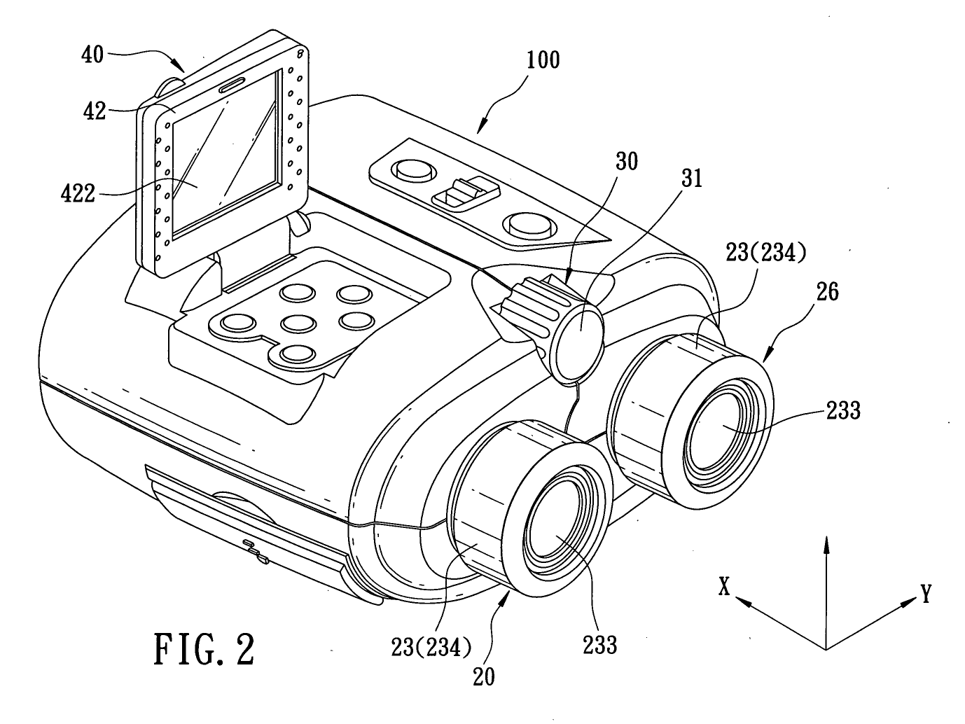

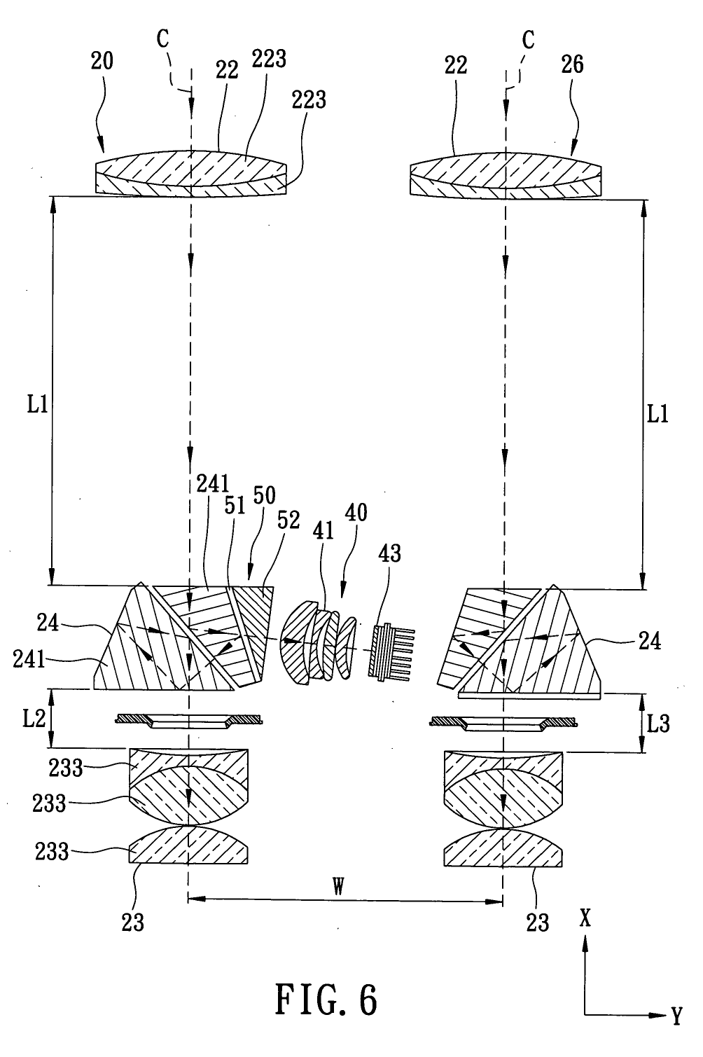

Referring to FIGS. 2, 3, and 4, the focusing and adjusting method of the present invention is applied to a pair of binoculars 100. The pair of binoculars 100 includes a frame 10, a pair of first and second optical units 20,26, a focusing assembly 30, an image-capturing unit 40, and a beam-splitting unit 50 (see FIG. 6).

The frame 10 includes a pair of upper plates 11, and a lower plate 12 spaced apart from the upper plates 11. The lower plate 12 includes a plurality of horizontal guide grooves 121, each corresponding in position to one of the first and second optical units 20,26.

Each of the first and second optical units 20,26 includes a lens barrel 21 extended along a first direction (X), disposed between the upper and lower plates 11, 12, and movable along a second direction (Y), which is perpendicular to the first direction (X), an objective lens unit 22 mounted in one end of the lens barrel 21, an ocular lens assembly 23 mounted to an opposite end of the lens barrel 21, and a prism assembly 24 (see FIG. 6) disposed in the lens barrel 21 between the objective lens unit 22 and the ocular lens assembly 23.

With particular reference to FIG. 6, an ocular width (W) of the binoculars 100 is defined as a distance along the second direction (Y) between longitudinal axes (C) of the first and second optical units 20,26. Furthermore, for each of the first and second optical units 20,26, a first optical length (L1) is defined as a distance between the objective lens unit 22 and the prism assembly 24 along the first direction (X). Moreover, a distance between the prism assembly 24 and the ocular lens assembly 23 along the first direction (X) is designated either a second optical length (L2) (for the first optical unit 20) or a third optical length (L3) (for the second optical unit 26).

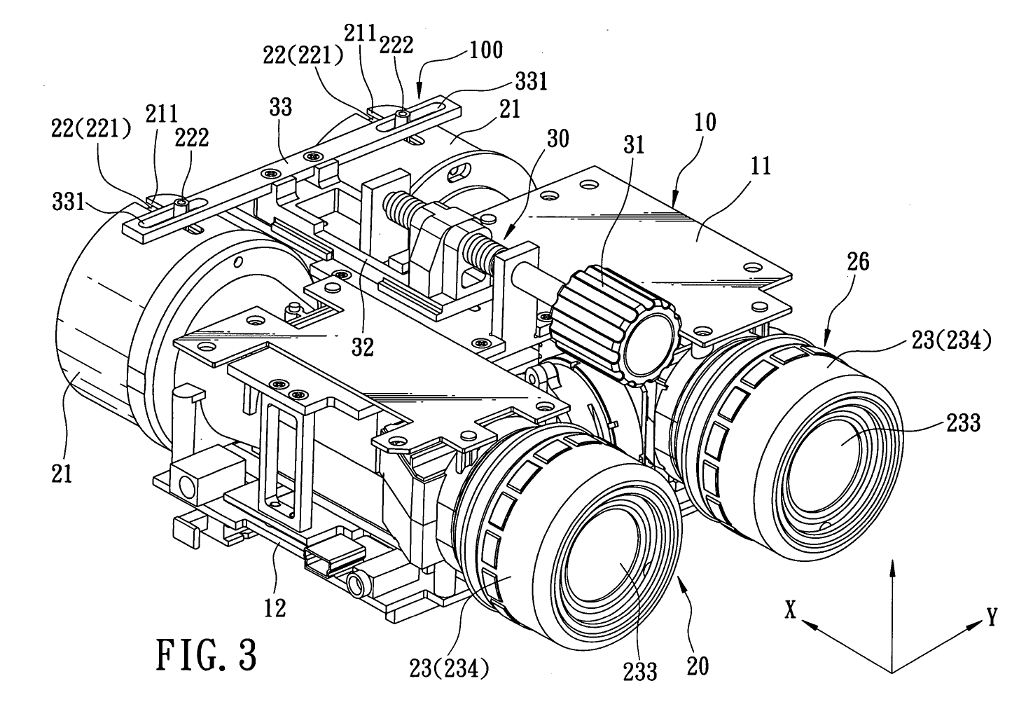

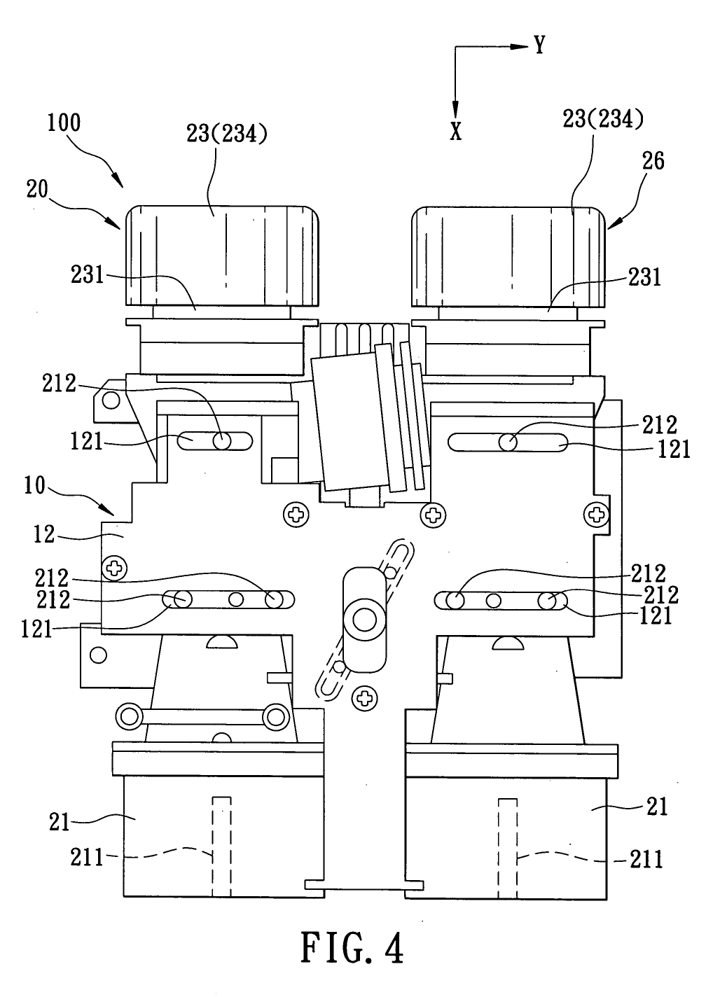

Referring to FIGS. 3 and 4, each of the lens barrels 21 is formed with an aperture 211 at an end thereof and that is extended along the first direction (X), and a plurality of first guide pins 212, each slidably engaged with one of the guide grooves 121 in the lower plate 12 of the frame 10. Through the slidable engagement of the first guide pins 212 in the guide grooves 121, when the user pushes the lens barrels 21 together or pulls the same apart (i.e., operates the lens barrels 21 in opposite directions along the second direction (Y)), the lens barrels 21 move along the second direction (Y), and, simultaneously, the upper plates 11 move toward each other, thereby varying the ocular width (W).

With reference to FIGS. 3 and 6, each of the objective lens units 22 includes an inner barrel element 221 positioned within the corresponding lens barrel 21, a second guide pin 222 protruding from the inner barrel element 221 and extending through the aperture 211, and a pair of objective lenses 223 mounted adjacent to one another.

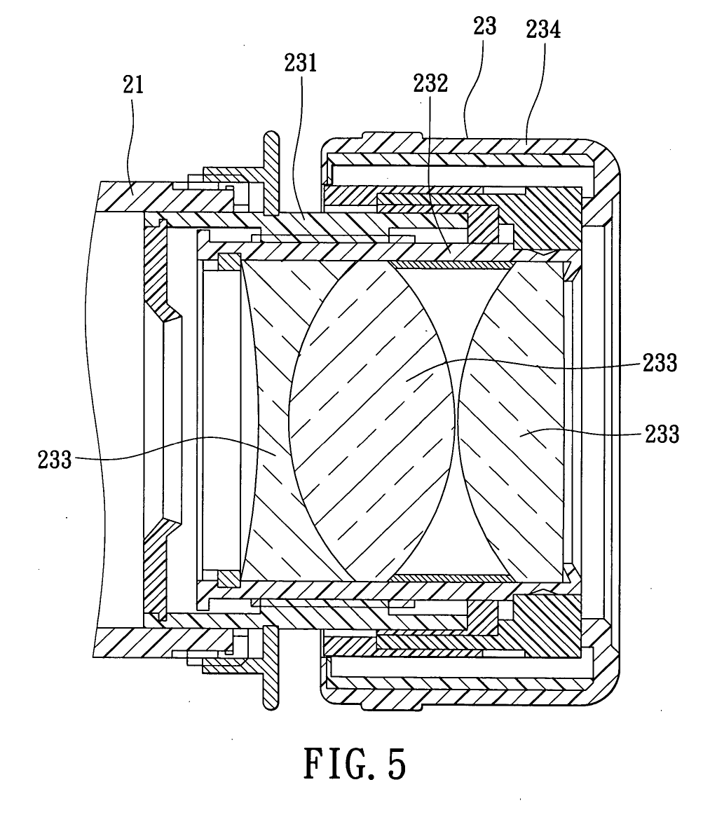

Referring to FIGS. 5 and 6, each of the ocular lens assemblies 23 includes a fixed barrel 231 fixedly connected to a rear end of the corresponding lens barrel 21, an adjustable barrel 232 screw-coupled to the fixed barrel 231, three lenses 233 mounted adjacent to one another within the adjustable barrel 232, and an adjusting ring 234 fixed to the adjustable barrel 232. When the user rotates the adjusting ring 234 of one of the ocular lens assemblies 23, the corresponding adjustable barrel 232 is displaced such that the corresponding group of the lenses 233 is moved relative to the fixed barrel 231 along the first direction (X). Hence, the second or third optical length (L2, L3) is varied, thereby allowing custom focusing for each eye of the user.

Referring to FIG. 6, each of the prism assemblies 24 includes a pair of prisms 241 mounted adjacent to one another.

As shown in FIG. 3, the focusing assembly 30 is mounted between the upper plates 11 of the frame 10. The focusing assembly 30 includes a bolt 31 extended along the first direction (X), a slide member 32 extended along the first direction (X) and coupled to the bolt 31, and a focus rod 33 mounted to a front end of the slide member 32 and extended along the second direction (Y). The focus rod 33 is formed with a pair of elongated holes 331 extended and spaced apart by a predetermined distance along the second direction (Y). The second guide pins 222 of the objective lens units 22, which pass respectively through the apertures 211 in the lens barrels 21, are extended respectively into the holes 331 in the focus rod 33.

When the lens barrels 21 are moved in opposite directions along the second direction (Y), the second guide pins 222 move along the holes 331, respectively. Further, with reference to FIGS. 3 and 6, when the user rotates the bolt 31 to thereby drive the slide member 32 to move along the first direction (X), the slide member 32, in turn, drives the focus rod 33 along the first direction (X). Since the guide pins 222 pass through the apertures 211 and are positioned in the holes 331 as described above, such movement of the focus rod 33 along the first direction (X) results in concurrent movement of the objective lens units 22 to thereby simultaneously vary the optical lengths (L1) of the optical units 20,26.

Referring to FIGS. 2 and 6, the image-capturing unit 40 includes a lens cluster 41, a display 42 having a screen 422, and an image sensor 43 disposed between the lens cluster 41 and the display 42. In the preferred embodiment, the display 42 is a liquid crystal display. The image sensor 43 may be a charge coupled device (CCD), or may utilize complementary metal oxide semiconductor (CMOS) technology. The image sensor 43, in addition to cooperating with the display 42 to allow for immediate viewing of captured images, cooperates also with an analog-to-digital converter, a microprocessor, memory, etc. (all not shown) to allow for the captured images to be stored and transferred to, for example, a personal computer. Since the structure and processes involved for allowing such functionality are well known in the art, a detailed description thereof will not be provided herein for the sake of brevity.

The beam-splitting unit 50 is disposed between the prism assembly 24 of the first optical unit 20 and the lens cluster 41 of the image-capturing unit 40. The beam-splitting unit 50 includes a light filter 51, and an auxiliary prism 52 disposed on the innermost prism 241 of the corresponding prism assembly 24 with the light filter 51 interposed therebetween. Light entering the objective lens units 22 travels to the ocular lens assemblies 23 after passing through the prism assemblies 24. For the first optical unit 20, part of the light that passes through the corresponding prism assembly 24 is filtered to the lens cluster 41 through the light filter 51 of the beam-splitting unit 50. As a result, the light entering the first and second optical units 20,26 is transmitted to the ocular lens assemblies 23 for viewing by the user, as well as to the image sensor 43 for display on the screen 422 of the display 42 (see FIG. 2) and storage in the memory (not shown).

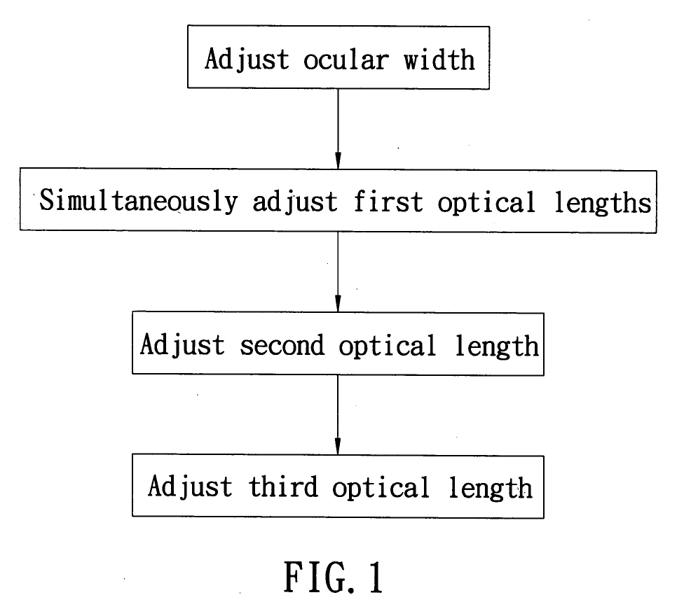

Referring to FIG. 1, the preferred embodiment of a focusing and adjusting method for the binoculars described above includes the following steps:

First, the ocular width (W) is adjusted by moving the lens barrels 21 in opposite directions along the second direction (Y) such that the second guide pins 222 of the objective lens units 22 move respectively within the holes 331 in the focus rod 33. In the case where the pair of binoculars is not configured to allow for ocular width adjustment, this step is omitted.

Next, the two first optical lengths (L1) are simultaneously adjusted. This is performed by rotating the bolt 31 to drive the slide member 32 to move along the first direction (X). As a result, the slide member 32 drives the focus rod 33 along the first direction (X), thereby resulting in concurrent movement of the objective lens units 22 through engagement of the second guide pins 222 with the holes 331 in the focus rod 33.

Subsequently, the second optical length (L2) is adjusted by rotating the adjusting ring 234 of the corresponding ocular lens assembly 23 of the first optical unit 20, thereby allowing custom focusing for one eye of the user.

Finally, the third optical length (L3) is adjusted by rotating the adjusting ring 234 of the ocular lens assembly 23 of the second optical unit 26, thereby allowing custom focusing for the other eye of the user.

With the use of the focusing and adjusting method for digital binoculars of the present invention described above, focusing control may be performed simultaneously with respect to the images viewed by the user, as well as the images appearing on the display 42 of the image-capturing unit 40. In addition, ocular width adjustment between the first and second optical units 20,26 may also be performed.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A focusing and adjusting method to be implemented using a pair of binoculars having first and second optical units, an image-capturing unit, and a beam-splitting unit, each of the first and second optical units including an objective lens unit, an ocular lens assembly spaced apart from the objective lens unit along a first direction, and a prism assembly disposed between the objective lens unit and the ocular lens assembly, the beam-splitting unit being disposed between the prism assembly of the first optical unit and the image-capturing unit, light entering the objective lens units passing through the prism assemblies for transmission to the ocular lens assemblies, the beam-splitting unit filtering part of the light that passes through the prism assembly of the first optical unit for supply to the image-capturing unit, said focusing and adjusting method comprising:
(a) adjusting an ocular width, which is defined as a distance along a second direction that is perpendicular to the first direction between longitudinal axes of the first and second optical units;
(b) simultaneously adjusting a pair of first optical lengths, each of which is defined as a distance along the first direction between the objective lens unit and the prism assembly of either one of the first and second optical units;
(c) adjusting a second optical length, which is defined as a distance along the first direction between the prism assembly and the ocular lens assembly of the first optical unit, thereby allowing custom focusing for one eye of a user; and
(d) adjusting a third optical length, which is defined as a distance along the first direction between the prism assembly and the ocular lens assembly of the second optical unit, thereby allowing custom focusing for the other eye of the user.

2. A focusing method to be implemented using a pair of binoculars having first and second optical units, an image-capturing unit, and a beam-splitting unit, each of the first and second optical units including an objective lens unit, an ocular lens assembly spaced apart from the objective lens unit along a first direction, and a prism assembly disposed between the objective lens unit and the ocular lens assembly, the beam-splitting unit being disposed between the prism assembly of the first optical unit and the image-capturing unit, light entering the objective lens units passing through the prism assemblies for transmission to the ocular lens assemblies, the beam-splitting unit filtering part of the light that passes through the prism assembly of the first optical unit for supply to the image-capturing unit, said focusing method comprising:
(a) simultaneously adjusting a pair of first optical lengths, each of which is defined as a distance along the first direction between the objective lens unit and the prism assembly of either one of the first and second optical units;
(b) adjusting a second optical length, which is defined as a distance along the first direction between the prism assembly and the ocular lens assembly of the first optical unit, thereby allowing custom focusing for one eye of a user; and
(c) adjusting a third optical length, which is defined as a distance along the first direction between the prism assembly and the ocular lens assembly of the second optical unit, thereby allowing custom focusing for the other eye of the user.
